(19) United States
(12) Patent Application Publication
(10) Pub. No.: US 2020/0157251 A1
(43) Pub. Date: May 21, 2020

(54) Pregelatinized Starches Having High Process Tolerance and Methods for Making and Using Them

(71) Applicant: Tate & Lyle Ingredients Americas LLC, Hoffman Estates, IL (US)

(72) Inventors: James Thomas Smoot, Hoffman Estates, IL (US); Yuqing Zhou, Hoffman Estates, IL (US)

(21) Appl. No.: 16/626,179

(22) PCT Filed: Jun. 26, 2018
(86) PCT No.: PCT/US2018/039588

§ 371 Date: Dec. 23, 2019

Related U.S. Application Data
(60) Provisional application No. 62/525,085, filed on Jun. 26, 2017.

(30) Foreign Application Priority Data
Aug. 2, 2017 (GB) 1712430.6

(51) Int. Cl. C08B 30/14; A23L 29/212; A23L 27/60; A23C 9/154

(52) U.S. Cl. CPC C08B 30/14; A23L 29/212; A23V 2002/00; A23C 9/1544; A23L 27/60

(57) ABSTRACT

This disclosure relates to pregelatinized starches having a high degree of process tolerance, and methods for making and using them. In one aspect, the disclosure provides a pregelatinized starch having no more than 15 wt % solubles and a sedimentation volume in the range of 20 mL/g to 45 mL/g, the pregelatinized starch being in the form of agglomerates comprising starch particles, the pregelatinized starch being in a substantially planar form. In another aspect, the disclosure provides a pregelatinized starch having no more than 15 wt % solubles, and a sedimentation volume in the range of 20 mL/g to 45 mL/g, the pregelatinized starch being in the form of agglomerates comprising starch particles. In certain embodiments, the starch is drum-dried. In certain embodiments, the pregelatinized starches of the disclosure have a Yellowness Index no more than 10.

### CROSS-REFERENCE TO RELATED APPLICATIONS

This application claims the benefit of priority of U.S. Provisional Patent Application No. 62/525,085, filed Jun. 26, 2017, which is hereby incorporated herein by reference in its entirety.

### BACKGROUND OF THE DISCLOSURE

### Field of the Disclosure

This disclosure relates generally to starches. More particularly, the present disclosure relates to pregelatinized starches having a high degree of process tolerance, and methods for making and using them.

### Technical Background

Food-grade starches are commonly used to provide desirable qualities to various foodstuffs. For example, cross-linked and stabilized modified food starches are used widely for texturizing of foods. The stabilization imparts freeze-thaw stability to a starch, while cross-linking imparts process tolerance. Stabilization can be provided via substitution of the starch hydroxyl groups by groups such as hydroxypropyl ethers or acetyl esters. Process tolerance can be obtained by cross-linking with groups such as phosphate (e.g., via treatment of the starch with phosphorous oxychloride) or adipate (e.g., via treatment with acetic-adipic mixed anhydride). As used herein, the term “process tolerant” or “process tolerance” with respect to an instant starch means that the individual granules of the starch may be, to a large extent broken, but the material swells in water when cooked yet retains a significant portion of its particulate nature throughout the process. Thus, process-tolerant starches can resist breaking down into smaller fragments and can resist dissolution when processed. Such behavior can allow the starch to thicken a food without causing undesired gelation, cohesiveness or stringiness. Accordingly, process-tolerant starches are highly desirable for use in foods such as gravies, sauces and dressings, as well as certain fruit fillings and dairy products. Such process-tolerant starches, however, require the use of chemical modification of the starch. But chemical modification requires additional process steps and cost, and, perhaps even more importantly, is viewed by consumers as undesirable. Native starches are not “chemically modified,” but lack the necessary process tolerance, and so generate an undesirably high degree of solubles. And the current options for “clean label”, process-tolerant texturizing starches suffer from significant color and flavor, which can undesirably be carried through to a final food product (e.g., a dairy product).

In many applications, a starch needs to be cooked, often at relatively high temperatures approaching 100° C., in order to provide a desired textural behavior in a given food product. However, there are various techniques known to pre-cook, or “pregelatinize,” a starch; such pregelatinized starches can be used to provide a desired viscosity in a food product without requiring the food product to be heated at such high temperatures. Some such pregelatinization methods include spray cooking, drum drying, and pre-swelling in aqueous alcohol. Drum drying involves the passing of a moistened starch material over a hot rotating drum and squeezing it through a narrow opening made between the drum and another surface (e.g., another rotating drum). The process is performed at temperatures sufficient to not only pregelatinize the starch but also to dry much of the water out of it, providing the starch in the form of a dried sheet or flakes, which can be processed to a desired flake or particle size. While drum drying is the least expensive of these technologies, as the inventors have determined (and as described in more detail below), drum drying has a negative impact on the integrity of the starch granules, and can provide starch materials that provide undesirable textures to foods, such as cohesiveness and stringiness. Drum-dried starches typically provide dispersions having lower viscosity than do spray-cooked and alcohol-processed starches when produced at equivalent process tolerance. And they can have a high degree of solubles, which can result in cohesiveness, which is undesirable. Drum drying can also result in significantly reduced process tolerance.

### SUMMARY OF THE DISCLOSURE

In one aspect, the disclosure provides a pregelatinized starch having no more than 15 wt % solubles, and a sedimentation volume in the range of 20 mL/g to 45 mL/g, the pregelatinized starch being in the form of agglomerates comprising starch particles, the pregelatinized starch being in a substantially planar form. In certain embodiments, the starch is drum-dried. In certain desirable embodiments, the pregelatinized starch has a Yellowness Index no more than 10.

In another aspect, the disclosure provides a pregelatinized starch having no more than 15 wt % solubles, and a sedimentation volume in the range of 20 mL/g to 45 mL/g, the pregelatinized starch being in the form of agglomerates comprising starch particles. In certain desirable embodiments, the pregelatinized starch has a Yellowness Index no more than 10. In certain embodiments, the starch is drum-dried.

In another aspect, the disclosure provides a method for making a pregelatinized starch as described herein, comprising providing an ungelatinized starch moistened with an aqueous medium; and drum-drying the moistened ungelatinized starch under conditions sufficient to pregelatinize the starch.

In another aspect, the disclosure provides a food product including a pregelatinized starch as described herein.

### BRIEF DESCRIPTION OF THE DRAWINGS

The disclosure can be more fully understood with reference to the drawings, in which:

FIG. 1 is a micrograph of a conventional non-pregelatinized hydroxypropylated modified starch, dispersed in water under the RVA conditions described herein;

FIG. 2 is a micrograph of a conventional hydroxypropylated modified starch, pregelatinized by spray cooking and dispersed in water under the RVA conditions described herein;

FIG. 3 is a micrograph of a conventional hydroxypropylated modified starch, pregelatinized by drum drying and dispersed in water under the RVA conditions described herein;

FIG. 4 is a micrograph of a native waxy starch before being cooked;

FIG. 5 is a micrograph of the native waxy starch of FIG. 4 after being treated to RVA conditions;

FIG. 6 is a micrograph of a starch of the disclosure before being cooked,

FIG. 7 is a micrograph of the starch of FIG. 6 after being treated to RVA conditions;

FIG. 8 is a micrograph of an example of a drum-dried starch;

FIG. 9 is a set of pictures used in springiness evaluation;

FIG. 10 is a set of pictures used in determining settling speed;

FIG. 11 is a set of pictures used in determining degree of agglomeration;

FIGS. 12 and 13 are an RVA plot and a hydration RVA plot for samples of Example 1;

FIG. 14 provides data for dispersion characteristics of a sample of Example 1;

FIGS. 15 and 16 are an RVA plot and a hydration RVA plot for samples of Example 2;

FIG. 17 provides data for dispersion characteristics of a sample of Example 2;

FIG. 18 provides textural data for the Bavarian creams of Example 3;

FIG. 19 provides textural data for the spoonable salad dressings of Example 3; and

FIG. 20 provides textural data for the fruit fillings of Example 3.

### DETAILED DESCRIPTION

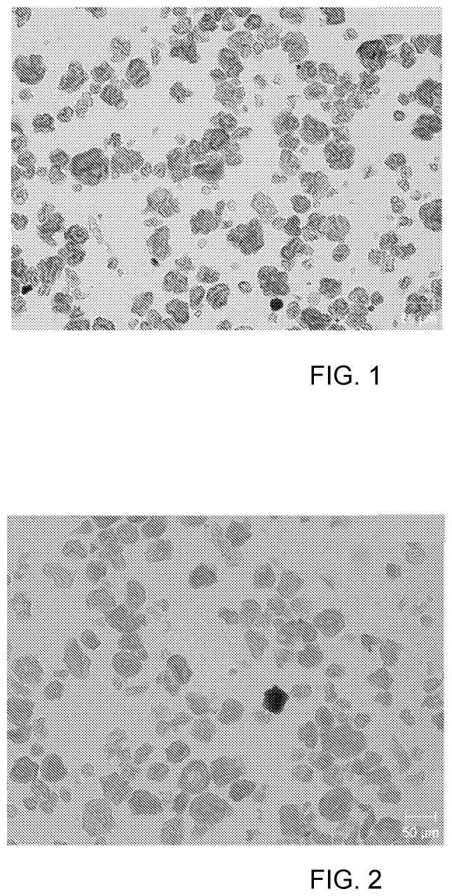

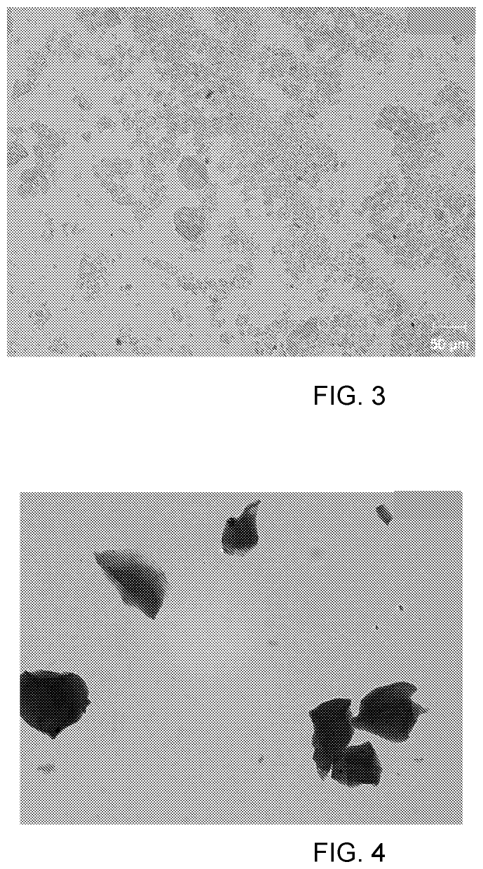

While drum drying is a cost-effective method for pregelatinization, as noted above, it can have an undesirable impact on starch performance. For example, FIG. 1 is a micrograph of a conventional non-pregelatinized hydroxypropylated modified starch, dispersed in water under the RVA conditions described below. As is evident, the individual particles of the starch remain substantially intact. When this starch is pregelatinized by spray-cooking then dispersed in water under the RVA conditions described below, it results in particles that swell but do not substantially fragment or disintegrate, as shown in FIG. 2. In contrast, when the starch of FIG. 1 is pregelatinized by drum drying, the resulting planar sheet- or flake-like agglomerates break apart when reintroduced to water yielding mostly particles which are visibly evident to be fragments as shown in FIG. 3. These fragments are visually distinct from the intact unfragmented particles of FIGS. 1 and 2. Drum drying of the starch can thus lead to a loss in process tolerance, as well as an increased amount of soluble starch, which can provide undesirable textural qualities to the starch.

Surprisingly, the present inventors have been able to use drum drying to provide pregelatinized starch materials that can provide both process tolerance and highly desirable texturizing properties. Thus, one aspect of the disclosure is a pregelatinized starch having less than 15 wt % solubles, and a sedimentation volume in the range of 20 mL/g to 45 mL/g (and in certain embodiments, a Yellowness Index no more than 10). The pregelatinized starch can be in the form of agglomerates comprising starch particles; in certain desirable embodiments, at least 50% of the starch particles swell but do not substantially fragment when processed in water. The pregelatinized starch of this aspect of the disclosure can be, for example, a drum-dried starch.

Moreover, the pregelatinized starches of the disclosure can be provided in substantially planar form. Accordingly, another aspect of the disclosure is a pregelatinized starch having less than 15 wt % solubles, and a sedimentation volume in the range of 20 mL/g to 45 mL/g (and in certain embodiments, a Yellowness Index no more than 10). The pregelatinized starch can be in the form of agglomerates comprising starch particles; in certain desirable embodiments, at least 50% of the starch particles swell but do not substantially fragment when processed in 95° C. water. According to this aspect of the disclosure, the pregelatinized starch is in a substantially planar form. As used herein, a “substantially planar” form means that at least 50%, at least 75%, or even at least 90% of the material by weight is in the form of individual sheet- or flake-like particles of material each having a thickness that is no more than ½ (e.g., in certain embodiments as otherwise described herein, no more than ⅓ or no more than ¼) of each of the length and the width of the particle. Thickness is measured as the average thickness along the shortest dimension, while length is measured as the longest dimension perpendicular to the thickness, and width is measured as the longest dimension perpendicular to both the thickness and the length. In certain embodiments as otherwise described herein, a pregelatinized starch of this aspect of the disclosure is a drum-dried starch.

Sedimentation volume can be used as a measure of process tolerance, as the person of ordinary skill in the art will appreciate. As used herein, sedimentation volume is the volume occupied by one gram of cooked starch (dry basis) in 100 grams (i.e. total, including the starch) of salted buffer solution. This value is also known in the art as “swelling volume.” As used herein, the “salted buffer solution” refers to a solution prepared according to the following steps:

Using a top loader balance, weigh out 20 grams of sodium chloride into a 2 liter volumetric flask containing a stir bar;
To this add RVA pH 6.5 buffer (purchased from Ricca Chemical Company) so that the flask is at least half full;
Stir to mix until sodium chloride is dissolved;
Add additional RVA pH 6.5 buffer to a final volume of 2 liters;
Sedimentation volumes as described herein are determined by first cooking the starch at 5% solids in the salted buffer solution by suspending a container containing the slurry in a 95° C. water bath and stirring with a glass rod or metal spatula for 6 minutes, then covering the container and allowing the paste to remain at 95° C. for an additional 20 minutes. The container is removed from the bath and allowed to cool on the bench. The resulting paste is brought back to the initial weight by addition of water (i.e. to replace any evaporated water) and mixed well. 20.0 g of the paste (which contains 1.0 g starch) is weighted into a 100 mL graduated cylinder containing salted buffer solution, and the total weight of the mixture in the cylinder is brought to 100 g using the buffer. The cylinder is allowed to sit undisturbed at room temperature (about 23° C.) for 24 hours. The volume occupied by the starch sediment (i.e., as read in the cylinder) is the sedimentation volume for 1 g of starch, i.e., in units of mL/g.

Starches with relatively low sedimentation volumes (e.g., in the range of 20 mL/g to 30 mL/g) have good process tolerance. In certain embodiments as otherwise described herein, the pregelatinized starch has a sedimentation volume in the range of 20 mL/g to 37 mL/g, or 20 mL/g or 32 mL/g, or 20 mL/g to 27 mL/g, or 20 mL/g to 24 mL/g, or 24 mL/g to 45 mL/g, or 24 mL/g to 37 mL/g, or 24 mL/g or 32 mL/g, or 24 mL/g to 30 mL/g, or 24 mL/g to 27 mL/g, or 27 mL/g to 45 mL/g, 27 mL/g to 37 mL/g, or 27 mL/g to 30 mL/g. In certain particular embodiments as otherwise described herein, the pregelatinized starch has a sedimentation volume in the range of 20 mL/g to 25 mL/g.

In the sedimentation volume test described above, the supernatant above the granular sediment contains soluble starch, i.e., the portion of the starch that is not retained by the inhibited granules of the sediment. The amount of soluble starch is quantified by withdrawing a portion of the supernatant, and quantitatively hydrolyzing the starch to dextrose using acid or enzyme, then measuring the concentration of dextrose, e.g., using an instrumental analyzer such as a glucose analyzer available from YSI Incorporated. The concentration of dextrose in the supernatant can be converted algebraically to the percent solubles (i.e., by weight) value of the starch.

If a starch releases a high degree of material from its granules when processed in a food, it can provide a degree of cohesiveness or stringiness to the food. While this is desirable in some foods, it is very undesirable in other foods. Accordingly, for certain uses, e.g., dressings, sauces and gravies, and certain fruit fillings and dairy products, a pregelatinized starch with a low amount of solubles is desired. Conventional drum-dried starches tend to have a high degree of solubles. In contrast, the pregelatinized starches of the disclosure have no more than 15% solubles. Accordingly, the pregelatinized starches of the disclosure can provide desired texturizing properties without an undesirable amount of cohesiveness or stringiness. In certain embodiments as otherwise described herein, a pregelatinized starch has no more than 10% solubles. In certain particular embodiments as otherwise described herein, a pregelatinized starch has no more than 5% solubles, e.g., no more than 4% solubles, or no more than 2% solubles.

The pregelatinized starches of the disclosure include a number of discrete starch particles, i.e., the individual particles that result upon dispersion of the starch into a liquid. An individual agglomerate of dried starch will contain a great many such particles, as would be apparent to the person of ordinary skill in the art. Particles can be, for example, intact granules or fragments of granules. The particle size will depend on the plant source of the starch as well as the degree to which the native starch granules are physically fragmented during processing.

Notably, in the pregelatinized starches of the disclosure, the starch particles swell but do not substantially fragment when processed in 95° C. water. As used herein, “processed in 95° C. water” means the conditions of a Rapid Visco Analyzer (RVA) experiment: Viscosity is measured by RVA at 5% solids in a pH 6.5 phosphate buffer at 1% NaCl. The pregelatinized starch is added to water at 35° C., and stirred at 35° C. at 700 rpm for one minute and at 160 rpm for 14 minutes; stirring at 160 rpm continues throughout the measurement. The temperature is linearly ramped to 95° C. over 7 minutes, then held at 95° C. for 10 minutes, then linearly ramped down to 35° C. over 6 minutes, then finally held at 35° C. for 10 minutes. Viscosity can be measured at this point, and the resulting starch dispersion can be stained with iodine and observed with a microscope to determine the degree of fragmentation. The staining is performed as follows: dilute 1 g of starch paste with 4 g of deionized water in a glass vial. After thorough mixing, 5 microliters of the sample is diluted with 5 microliters of 0.1 N iodine solution on a microscope slide, and mixed well. The sample is covered with a cover slip and imaged at 200×. The degree of fragmentation can be determined by comparing the area in the field of view of the microscope taken by unfragmented particles as a fraction of the total area in the field of view taken by unfragmented particles and particle fragments. For example, in certain embodiments, a pregelatinized starch as otherwise described herein has a degree of fragmentation of no more than 50%, i.e., the area of unfragmented particles divided by the sum of the areas of unfragmented particles and particle fragments is no more than 50%. In other embodiments, a pregelatinized starch as otherwise described herein has a degree of fragmentation of no more than 30%, or even no more than 10%.

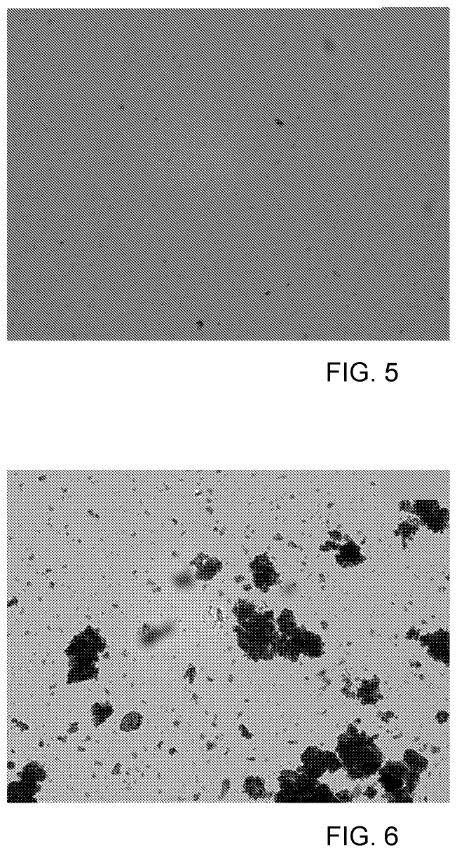

FIG. 4 is a micrograph of a native waxy starch, imaged as described above, before being cooked, and FIG. 5 is a micrograph of the same starch after being treated to the RVA conditions described above. FIG. 6 is a micrograph of a starch of the disclosure before being cooked, and FIG. 7 is a micrograph of a starch of the disclosure after being treated to the RVA conditions described above.

In certain embodiments of the pregelatinized starches as otherwise described herein, at least 75% of the starch particles swell but do not substantially disintegrate when processed in 95° C. water. In certain particular embodiments of the pregelatinized starches as otherwise described herein, at least 90% of the starch particles swell but do not substantially disintegrate when processed in 95° C. water.

As noted above, the starches of the disclosure are pregelatinized. As the person of ordinary skill in the art will appreciate, the pregelatinization process disorganizes the semicrystalline structure of the native starch granule, such that it can later provide viscosity to a food without needing to be processed at high temperatures. As used herein, a “pregelatinized” starch has no more than 25% of its particles exhibiting birefringence, i.e., a high-extinction, so-called “Maltese” cross through the particle when viewed by polarization microscopy. For example, in certain embodiments, no more than 10%, no more than 5%, or even no more than 2% of the particles of the pregelatinized starch exhibit birefringence.

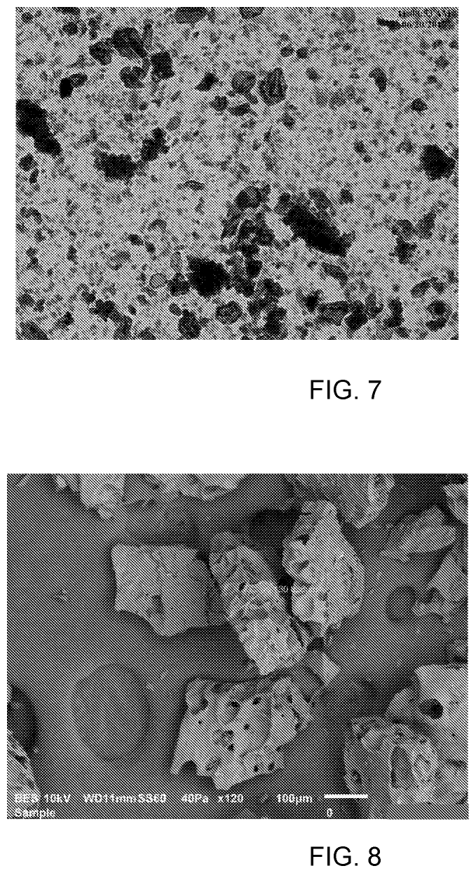

Notably, in certain aspects of the disclosure, the pregelatinized starch as otherwise described herein is a drum-dried starch. While drum drying is an economically attractive pregelatinization method, it can cause undesirable damage to a starch material. For example, conventional drum-dried starches can suffer from undesirable properties such as a high degree of cohesiveness and stringiness, resulting from disintegration of starch granules causing a high amount of soluble material. The pregelatinized starches of these aspects of the present disclosure, in contrast, have low amounts of solubles and good processability despite being drum dried. Conventional drum drying equipment and processes can be used to provide the drum-dried starches of the disclosure. As the person of ordinary skill in the art will appreciate, a typical drum dryer includes one or two horizontally-mounted hollow cylinder(s), with a feeding system configured to apply a thin layer of liquid, slurry or puree to the face of one or both cylinders. In a drying operation, the drums are heated to dry and, depending on the temperature, cook the material of the liquid, slurry or puree to form a thin solid layer of material, which can be removed from the drum by a scraper and ground or milled to a desired size. Drum dryers are described in more detail in J. Tang et al., Drum Drying, pages 211-14 in Encyclopedia of Agricultural, Food, and Biological Engineering, Marcel Dekker, 2003, which is hereby incorporated herein by reference in its entirety. Particular drum drying apparatuses and processes are described below; the person of ordinary skill in the art will appreciate that a variety of drum- and roll-drying apparatuses and conditions can be used to provide the “drum-dried” materials described herein. The person of ordinary skill in the art will appreciate that drum-dried starch materials have a different dry appearance than do spray-cooked or alcohol-processed starches. A micrograph of an example of a drum-dried starch is provided in FIG. 8. For example, drum drying can provide dry starch materials having a sheet-like or flake-like agglomerate appearance, and/or a cratered appearance as described in more detail below, and as shown in FIG. 8.

In certain embodiments as otherwise described herein, the agglomerates of the pregelatinized starch (e.g., at least 50%, at least 75%, or at least 90% by weight thereof) have a substantially non-rounded shape (e.g., a jagged shape). Such agglomerates can be made, for example, by drum drying as described above; individual agglomerates can be formed by breaking or grinding of a dried sheet of material. The substantially non-rounded shape of such material is in contrast to the rounded agglomerates made by spray cooking or alcohol processing.

In certain embodiments as otherwise described herein, the agglomerates of the pregelatinized starch (e.g., at least 50%, at least 75%, or at least 90% by weight thereof) have a cratered surface. An example of such a surface is shown in FIG. 8. Such agglomerates can be made, for example, by drum drying as described above; especially at the higher drying temperatures desirable to give substantial pregelatinization, drum-drying can provide starch agglomerates having a cratered surface, resulting from water escaping from the drying material in the form of steam.

In certain embodiments as otherwise described herein, at least 75% by weight of the pregelatinized starch (e.g., 90% by weight thereof) is in the form of individual sheet- or flake-like agglomerates of material each having a thickness that is no more than ½ of each of the length and the width of the agglomerate. Such agglomerates can be made, for example, by drum drying as described above, with an optional milling or grinding step to provide the agglomerate size.

In certain embodiments as otherwise described herein, at least 50% by weight of the pregelatinized starch (e.g., at least 75% or at least 90% by weight thereof) is in the form of individual sheet- or flake-like agglomerates of material each having a thickness that is no more than ⅓ of each of the length and the width of the agglomerate. In certain particular embodiments as otherwise described herein, at least 50% by weight of the pregelatinized starch (e.g., at least 75% or at least 90% by weight thereof) is in the form of individual sheet- or flake-like agglomerates of material each having a thickness that is no more than ¼ of each of the length and the width of the agglomerate. Such agglomerates can be made, for example, by drum drying as described above, with an optional milling or grinding step to provide the desired agglomerate size. Advantageously, in drum-drying processes the agglomerate size can be manipulated over a wider range than is typical for spray-cooked and/or agglomerates. As the dried starch is produced in the first instance as relatively large sheets, the agglomerate size can vary from large flakes to any finer grind desired. For example, drum-dried sheets can be ground to agglomerates hundreds of microns (e.g., 750 microns) in major dimension to provide a starch providing a pulpy texture to a food, down to on the order of 5-10 microns for a starch providing a smooth texture to a food.

As the person of ordinary skill in the art will appreciate, the pregelatinized starches described herein can be provided in a variety of agglomerate sizes (i.e., in substantially dry form). For example, in certain embodiments as otherwise described herein, at least 50% by weight of the pregelatinized starch (e.g., at least 75% or at least 90% by weight thereof) is in the form of individual sheet- or flake-like agglomerates of material each having a thickness in the range of 20 microns to 250 microns. For example, in various embodiments as otherwise described herein, at least 50% by weight of the pregelatinized starch (e.g., at least 75% or at least 90% by weight thereof) is in the form of individual sheet- or flake-like agglomerates of material each having a thickness in the range of 20 microns to 200 microns, or 20 microns to 150 microns, or 20 microns to 125 microns, or 20 microns to 100 microns, or 20 microns to 75 microns, or 30 microns to 250 microns, or 30 microns to 200 microns, or 30 microns to 150 microns, or 30 microns to 125 microns, or 30 microns to 100 microns, or 50 microns to 250 microns, or 50 microns to 200 microns, or 50 microns to 150 microns, or 50 microns to 125 microns, or 75 microns to 250 microns, or 75 microns to 200 microns, or 75 microns to 150 microns, or 75 microns to 125 microns, or 100 microns to 250 microns, or 100 microns to 200 microns. In certain embodiments as otherwise described herein, at least 50% by weight of the pregelatinized starch (e.g., at least 75% or at least 90% by weight thereof), i.e., agglomerates having the thicknesses described above, is in the form of individual sheet- or flake-like agglomerates of material each having a length of at least 50 microns, or at least 100 microns, or at least 200 microns, for example, at least 300 microns or at least 400 microns, or in the range of 50 microns to 1000 microns, or 50 microns to 800 microns, or 50 microns to 500 microns, or 50 microns to 250 microns, or 100 microns to 1000 microns, or 100 microns to 800 microns, or 100 microns to 500 microns, or 100 microns to 250 microns, 200 microns to 1000 microns, or 200 microns to 800 microns, or 200 microns to 500 microns, or 300 microns to 1000 microns, or 300 microns to 800 microns, or 300 microns to 500 microns, or 400 microns to 1000 microns, or 400 microns to 800 microns. Similarly, in certain embodiments as otherwise described herein, at least 50% by weight of the pregelatinized starch (e.g., at least 75% or at least 90% by weight thereof), i.e., agglomerates having the thicknesses and lengths described above, is in the form of individual sheet- or flake-like agglomerates of material each having a width of at least the range of at least 50 microns, or at least 100 microns, or at least 200 microns, for example, at least 300 microns or at least 400 microns, or in the range of 50 microns to 1000 microns, or 50 microns to 800 microns, or 50 microns to 500 microns, or 50 microns to 250 microns, or 100 microns to 1000 microns, or 100 microns to 800 microns, or 100 microns to 500 microns, or 100 microns to 250 microns, 200 microns to 1000 microns, or 200 microns to 800 microns, or 200 microns to 500 microns, or 300 microns to 1000 microns, or 300 microns to 800 microns, or 300 microns to 500 microns, or 400 microns to 1000 microns, or 400 microns to 800 microns. The planar agglomerates described above can be ground even smaller, e.g., to provide a agglomerate size down to the range of 1-20 microns (e.g., 5-10 microns).

For example, in certain embodiments as otherwise described herein, at least 50% by weight of the pregelatinized starch (e.g., at least 75% or at least 90% by weight thereof) is in the form of individual sheet- or flake-like agglomerates of material each having a thickness in the range of 20 microns to 250 microns; a length of at least 50 microns; and a width of at least 50 microns. In other embodiments as otherwise described herein, at least 50% by weight of the pregelatinized starch (e.g., at least 75% or at least 90% by weight thereof) is in the form of individual sheet- or flake-like agglomerates of material each having a thickness in the range of 20 microns to 250 microns; a length of at least 100 microns; and a width of at least 100 microns. In other embodiments as otherwise described herein, at least 50% by weight of the pregelatinized starch (e.g., at least 75% or at least 90% by weight thereof) is in the form of individual sheet- or flake-like agglomerates of material each having a thickness in the range of 20 microns to 250 microns; a length in the range of 200 microns to 1000 microns; and a width in the range of 200 microns to 1000 microns. In other embodiments as otherwise described herein, at least 50% by weight of the pregelatinized starch (e.g., at least 75% or at least 90% by weight thereof) is in the form of individual sheet- or flake-like agglomerates of material each having a thickness in the range of 50 microns to 250 microns; a length in the range of 100 microns to 1000 microns; and a width in the range of 100 microns to 1000 microns. The person of ordinary skill in the art will appreciate that in various other embodiments, at least 50% by weight of the pregelatinized starch (e.g., at least 75% or at least 90% by weight thereof) is in the form of individual sheet- or flake-like agglomerates of material each having any combination of the thicknesses, lengths and widths as described above (e.g., such that a sheet-like or flake-like agglomerate is formed).

A variety of different starch sources can be used to provide the starches of the disclosure, including blends of starch sources. As the person of ordinary skill in the art will appreciate, different types of starches from different sources can have different textures and rheological properties, and thus can be desirable for use in different food applications. The person of ordinary skill in the art will be able to use conventional microscopy methods and analytical techniques to distinguish between types of starches. For example, in certain embodiments as otherwise described herein, the pregelatinized starch is a corn starch. In other embodiments as otherwise described herein, the pregelatinized starch is a tapioca or cassava starch. In other embodiments as otherwise described herein, the pregelatinized starch is a potato starch. In other embodiments as otherwise described herein, the pregelatinized starch is a rice starch or a wheat starch. In still other embodiments as otherwise described herein, the pregelatinized starch is derived from acorns, arrowroot, arracacha, bananas, barley, breadfruit, buckwheat, canna, colacasia, katakuri, kudzu, melange, millet, oats, oca, polynesian arrowroot, sago, sorghum, sweet potatoes, rye, taro, chestnuts, water chestnuts, yams, or beans such as, for example, favas, lentils, mung beans, peas, or chickpeas. The starches can be waxy or non-waxy. The materials and methods of the disclosure can be practiced with respect to virtually any starch source, including natural starch sources.

As the person of ordinary skill in the art will appreciate, the starch feedstock may be purified, e.g., by conventional methods, to reduce undesirable flavors, odors, or colors, e.g., that are native to the starch or are otherwise present. For example, methods such as washing (e.g., alkali washing), steam stripping, ion exchange processes, dialysis, filtration, bleaching such as by chlorites, enzyme modification (e.g., to remove proteins), and/or centrifugation can be used to reduce impurities. The person of ordinary skill in the art will appreciate that such purification operations may be performed at a variety of appropriate points in the process. The starch may be washed using techniques known in the art to remove soluble low molecular weight fractions, such as mono- and di-saccharides and/or oligosaccharides.

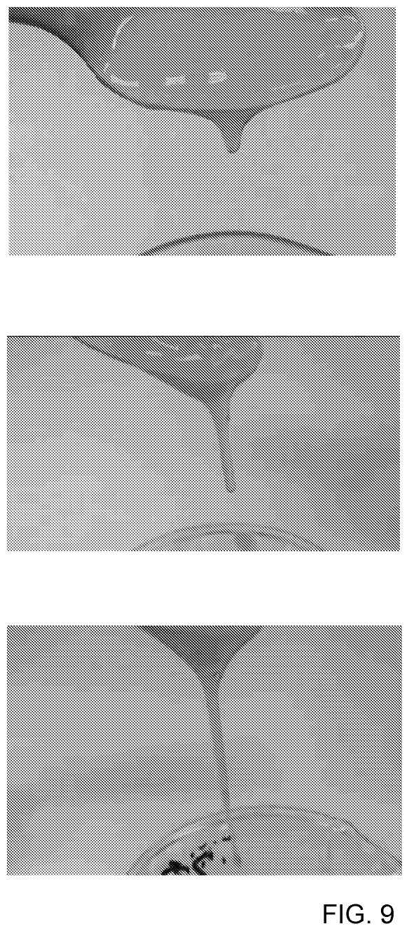

The pregelatinized starches described herein can provide a wide variety of textural benefits. For example, in certain embodiments as otherwise described herein, a pregelatinized starch can provide a low degree of cohesiveness (e.g., as measured by stringiness) in aqueous media. Such pregelatinized starches can be used to provide food product, such as gravies, sauces or dressings, with a desirably low cohesiveness. Stringiness can be determined by a sensory panel, e.g., a panel of testers trained to determine sensory characteristics of food ingredients, by comparison with the pictures in FIG. 9 (stringiness values of 3, 6 and 9, top-to-bottom). To prepare a starch sample for the stringiness evaluation, the starch is mixed with propylene glycol at 1:1 ratio using a plastic spatula until the starch is wet. The starch/propylene glycol mixture is placed under a Caframo mixer that is set at 825 RPM. The mixer is activated and the 1% (w/w) salt water is poured into the container holding the starch mixture. A spatula is used to make sure the starch is completely exposed to the salt water. The total amount of starch mixture is 2500 grams and the starch concentration is 6.5% (on a dry solids basis). The mixture is blended for 10 minute at 825 RPM. The starch paste is divided into 10 equal parts and put into 8 oz covered jars. Each jar has approximately 250 grams of product. The starch is continued to hydrate for 1 hour before evaluation. To determine stringiness, the sample is stirred well, then a spoonful of the material is scooped out of the jar and dropped slowly back into the container. The length of the tail when the starch leaves the spoon is observed and compared with the pictures of FIG. 9 to determine a stringiness value. In certain embodiments, a starch as otherwise described herein has a stringiness value of 5 or less, or 4 or less, or in the range of 1-5, or 1-4, or 2-5 or 2-4.

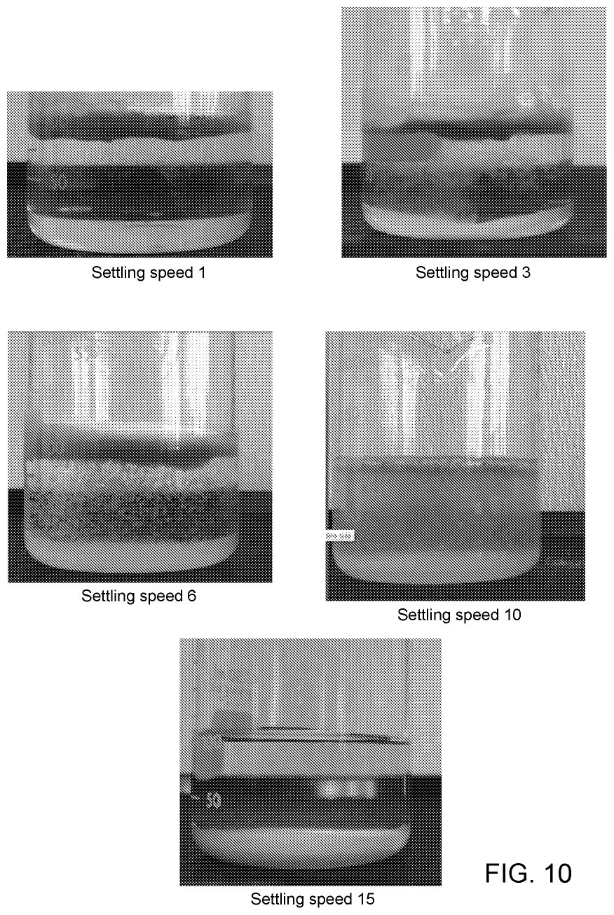

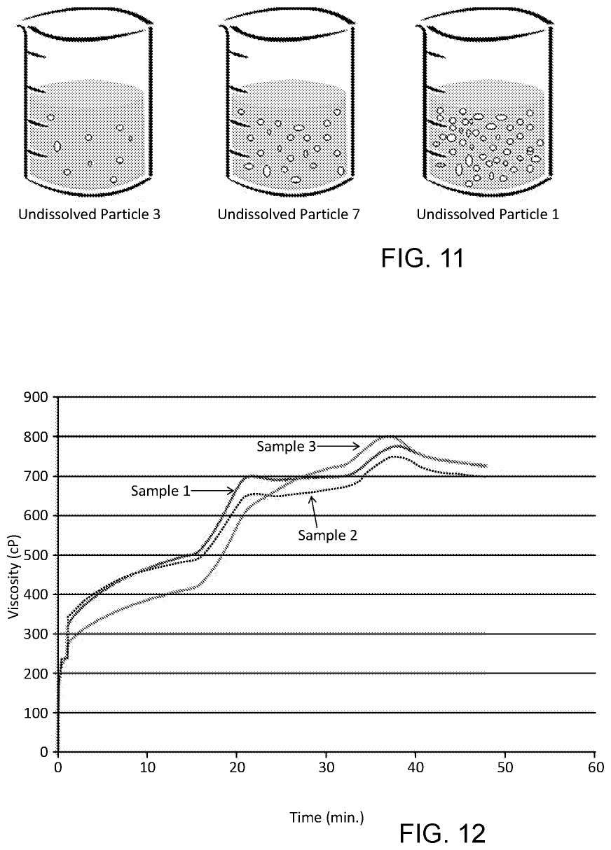

The dispersibility of the pregelatinized starch in aqueous media can be evaluated by dumping 5 grams of starch (as is) into 95 grams of 1% (w/w) salt water in a 250 mL beaker. The panelists observe the settling speed of the starch agglomerates over a 10 second timeframe, with comparison to the pictures in FIG. 10 being used to determine a settling speed value. The settling speed can be, for example, at least 1, or at least 5, or in the range of 1-15 or 5-15. The panelists then use mini whisk to stir the starch solution with moderate speed for 1 minute and assess the initial thickness, floating number, floating area, sediment (amount of settled agglomerates at the bottom), clump (large undispersed agglomerates in solution), graininess, phase separation, and thickness after 3 minutes. After the stirring, the amount of undissolved agglomerates can be compared with the pictures in FIG. 11, to determine an agglomerate value, e.g., of 0-15.

The pregelatinized starches described herein can have a variety of rates of hydration. Fast hydration can lead to clumping of the pregelatinized starch when it is dispersed directly in aqueous media, but clumping can be minimized by pre-dispersing the starch in other ingredients, e.g., oil or sugar. In contrast, a slower rate of hydration can allow for the minimization of clumping of the pregelatinized starch when it is dispersed directly in aqueous media. The person of ordinary skill in the art can influence the dispersibility of the material, for example, by controlling the particle size of the material (e.g., by grinding after drum-drying).

In certain embodiments as otherwise described herein, a pregelatinized starch is tolerant to shear. Shear tolerance can be measured by comparing sedimentation volume and solubles values of the starch before and after shear processing. In certain desirable embodiments as otherwise described herein, the sedimentation volume increases by no more than 25%, or even no more than 10% upon shear processing. In certain desirable embodiments, the amount of solubles increases by no more than 25%, or even no more than 10% upon shear processing. In certain embodiments as otherwise described herein, the starch has a degree of fragmentation of no more than 50%, no more than 30%, or even no more than 10% after shear processing. In certain such embodiments, the “shear processing” is treatment in a Waring blender (Model 51BL32) by shearing at 30V for forty seconds. The starch can optionally be cooked (e.g., by the RVA conditions) before shear processing.

The pregelatinized starches described herein can be made with relatively little color. For example, certain embodiments of the pregelatinized starches as otherwise described herein have a Yellowness Index of no more than 10, for example, in the range of 3-10 or 5-10. In certain desirable embodiments, the Yellowness Index is less than 8 (e.g., 3-8 or 5-8). Yellowness Index is determined via ASTM E313. Moreover, the pregelatinized starches described herein can be made with a high degree of shininess. Shininess can be determined by comparison with standard photo papers (Shininess 3: Kodak photo paper bar code 04177174332; Shininess 7: Kodak Ultra Premium Photo Paper bar code 04177183398; Shininess 11: Kodak Premium Photo Paper with laminating sheet on top. Kodak Premium photo paper bar code 04177103438).

Moreover, the pregelatinized starches described herein can be made with low flavor, such that they do not appreciably impact the flavor of a food product in which they are disposed.

Notably, in certain embodiments the pregelatinized starches described herein are not chemically modified. For example, in certain embodiments the pregelatinized starches described herein can be made without many of the conventional chemical modifiers used in making conventional modified and/or inhibited starches. Accordingly, in certain desirable embodiments, a pregelatinized starch as otherwise described herein can be marked or labelled as so-called “clean-label” starches. For example, in certain embodiments, a pregelatinized starch as otherwise described herein is not hydroxypropylated. In certain embodiments, a pregelatinized starch as otherwise described herein is not acetylated. In certain embodiments, a pregelatinized starch as otherwise described herein is not carboxymethylated. In certain embodiments, a pregelatinized starch as otherwise described herein is not hydroxyethylated. In certain embodiments, a pregelatinized starch as otherwise described herein is not phosphated. In certain embodiments, a pregelatinized starch as otherwise described herein is not succinated (e.g., not octenylsuccinated). In certain embodiments, a pregelatinized starch as otherwise described herein is not cationic or zwitterionic.

Similarly, in certain embodiments the pregelatinized starches described herein can be made without use of the cross-linking chemical modifiers typically used in the inhibition of starch. For example, in certain embodiments, a pregelatinized starch as otherwise described herein is not crosslinked with phosphate (e.g., using phosphorus oxychloride or metaphosphate). In certain embodiments, a pregelatinized starch as otherwise described herein is not crosslinked with adipate. In certain embodiments, a pregelatinized starch as otherwise described herein is not crosslinked with epichlorohydrin. In certain embodiments, a pregelatinized starch as otherwise described herein is not crosslinked with acrolein.

And the pregelatinized starches of the disclosure (e.g., having the yellowness values described above) can in certain embodiments be made without using other harsh chemical treatments common in the art. For example, in certain embodiments, a pregelatinized starch as otherwise described herein is not bleached or oxidized with peroxide or hypochlorite. Of course, in other embodiments, peroxide or hypochlorite can be used to provide even better color to the pregelatinized starches described herein.

In certain embodiments, the pregelatinized starches of the disclosure can be made without dextrinization, and as such do not contain substantial amounts of the repolymerized branched chains typical of dextrins. Accordingly, in such embodiments, a pregelatinized starch as otherwise described herein substantially lacks 1,2- and 1,3-branching (e.g., less than 1% of each). Such branching can be determined using nuclear magnetic resonance techniques familiar to the person of ordinary skill in the art.

The pregelatinized starches of the present disclosure can have a variety of viscosities as measured by a Rapid Visco Analyzer (RVA) using the method described above. For example, in certain embodiments a pregelatinized starch as otherwise described herein can have a viscosity as measured by RVA is in the range of 50-1500 cP. In certain such embodiments, the viscosity as measured by RVA is in the range of 50-1000 cP, 50-850 cP, 50-700 cP, 50-500 cP, 50-400 cP, 50-300 cP, 50-200 cP, 100-1100 cP, 100-1000 cP, 100-850 cP, 100-700 cP, 100-500 cP, 100-400 cP, 100-300 cP, 200-1100 cP, 200-1000 cP, 200-850 cP, 200-700 cP, 200-500 cP, 400-1100 cP, 400-1000 cP, 400-850 cP, 400-700 cP, 600-1100 cP, or 600-850 cP, 700-1500 cP, or 700-1300 cP. The viscosity is measured by RVA at 5% solids in a pH 6.5 phosphate buffer at 1% NaCl at a stir rate of 160 rpm. The initial temperature of the analysis is 50° C.; the temperature is ramped linearly up to 90° C. over 3 minutes, then held at 95° C. for 20 minutes, then ramped linearly down to 50° C. over 3 minutes, then held at 50° C. for 9 minutes, after which time the viscosity is measured. Notably, when a pasting peak is displayed at times of about 2-5 minutes, the final viscosity measured is higher than the pasting peak viscosity. When the pasting peak is absent, the viscosity during the 95° C. hold is flat, or increases. In certain embodiments, the starch exhibits a viscosity breakdown less than 3%, less than 2%, or even less than 1% over the 95° C. hold time of the viscosity measurement experiment.

In certain embodiments, the pregelatinized starches of the disclosure substantially retain intact particles upon cooking. As used herein, the degree of intact particles is determined by cooking the starch at 5% solids in the salted buffer solution by suspending a container containing the slurry in a 95° C. water bath and stirring with a glass rod or metal spatula for 6 minutes, then covering the container and allowing the paste to remain at 95° C. for an additional 20 minutes, then allowing the paste to cool to room temperature. Following such cooking, swollen but intact particles can be observed microscopically. The person of ordinary skill in the art would understand that minor deviations from the particulate nature are allowed. For example, in certain embodiments of the pregelatinized starches as otherwise described herein, no more than 30% of the starch particles become non-intact upon cooking (i.e. as described above). In certain such embodiments, no more than 20% or even no more than 10% of the starch particles become non-intact upon cooking (i.e., as described above). The person of ordinary skill in the art can determine whether starch particles remain intact by viewing them under a microscope (e.g., with staining), as is conventional in the art. Comparisons can be made between material dispersed in buffer immediately before and after the RVA cooking to determine what fraction of particles remain substantially intact. Certain desirable embodiments of the pregelatinized starches as described herein are substantially digestible. For example, in certain embodiments of the pregelatinized starches as otherwise described herein, the amount of fiber is less than 10% as determined by AOAC 2001.03. In certain such embodiments, the amount of fiber is less than 5% or even less than 2%.

Thus, the pregelatinized starches of the disclosure can be made to be process-tolerant in a cost-effective manner, and can provide non-cohesive instant thickening that is low in color and need not be marked as “modified” or with an “E-number” (i.e., signifying modification).

Another aspect of the disclosure is a method for making a pregelatinized starch as described herein. The method includes providing an inhibited ungelatinized starch moistened with an aqueous medium; and drum-drying the moistened inhibited ungelatinized starch under conditions to pregelatinize the starch, e.g., to a degree as described above with respect to the pregelatinized starches of the disclosure. In certain such embodiments, the inhibited ungelatinized starch is not stabilized, e.g., by acetylation or hydroxypropylattion, as described above with respect to the pregelatinized starches of the disclosure. And in certain such embodiments, the inhibited ungelatinized starch is not cross-linked, e.g., by phosphate or adipate, as described above with respect to the pregelatinized starches of the disclosure. The inhibited ungelatinized starch can be any of the starch types as described above. The person of ordinary skill in the art can use conventional drum-drying techniques to provide the starches described herein.

The inhibited ungelatinized starch from which the pregelatinized starches of the disclosure are made may be provided using a variety of methodologies. A variety of starch feedstocks can be used (e.g., a corn starch, a wheat starch, a rice starch, a tapioca starch, or any of the other starches described herein). The starch feedstock can be pre-treated, for example, to reduce the amount of lipid and/or protein present in the starch, as is conventional in the art.

In certain embodiments, the inhibited ungelatinized starch is made using the methods described in International Patent Application Publication no. WO 2013/173161, which is hereby incorporated herein by reference in its entirety. Thus, a method for making the starches described herein can include

a) heating a non-pregelatinized starch feedstock in an alcoholic medium in the presence of a base at a temperature of at least 35° C.;

b) neutralizing the base with an acid;

c) separating the inhibited ungelatinized starch from the alcoholic medium; and

d) removing alcohol solvent from the inhibited ungelatinized starch, e.g., by heating or with steam.

The alcoholic medium generally comprises at least one alcohol, particularly a C₁-C₄ monoalcohol such as methanol, ethanol, n-propanol, isopropanol, n-butanol, t-butyl alcohol and the like. One or more other substances may also be present in the alcoholic medium, such as a non-alcoholic organic solvent (particularly those that are miscible with the alcohol) and/or water. However, in one embodiment of the method the alcoholic medium does not contain any solvent other than alcohol and, optionally, water. Aqueous alcohols, for example, may be used to advantage. The alcoholic medium may comprise, for instance, 30% to 100% by weight alcohol (e.g., ethanol) and from 0% to 70% by weight water. In one embodiment, the alcoholic medium contains from 80% to 96% by weight alcohol (e.g., ethanol) and from 4% to 20% by weight water, the total amount of alcohol and water equaling 100%. In another embodiment, the alcoholic medium contains 90% to 100% by weight alcohol (e.g., ethanol) and from 0% to 10% by weight water, the total amount of alcohol and water equaling 100%. In other embodiments, not more than 10% or not more than 15% by weight water is present in the alcoholic medium. The quantity of alcoholic medium relative to starch is not considered to be critical, but typically for the sake of convenience and ease of processing sufficient alcoholic medium is present to provide a stirrable and/or pumpable slurry. For example, the weight ratio of starch:alcoholic medium may be from about 1:2 to about 1:6.

In certain methods, at least some amount of treatment agent (base and/or salt) is present when the ungelatinized starch feedstock is heated in the alcoholic medium. However, it is advantageous that large amounts of treatment agent (relative to starch) need not be used in order to achieve effective inhibition of the starch, in contrast to previously known starch modification processes. This simplifies the subsequent processing of the inhibited starch and lowers potential production costs. Typically, at least 0.5% by weight of treatment agent (based on the dry weight of starch used) is employed, although in other embodiments at least 1%, at least 2%, at least 3%, at least 4% or at least 5% by weight of treatment agent is present. For economic reasons, generally no more than 10% or 15% by weight of treatment agent is present.

Typically, the mixture of starch, alcoholic medium and treatment agent is in the form of a slurry. In certain embodiments, it may be desirable to adjust the pH of the slurry to a particular value. It can be difficult to measure the pH of such a slurry due to the presence of the alcohol. In an embodiment where it is desired to make the slurry basic by adding a base, a suitable amount of base can be determined as if the slurry is a slurry of starch in deionized water alone and then scaled up to the actual amount while keeping the same ratio of base and starch.

The slurry may, for example, be neutral (pH 6 to 8) or basic (pH greater than 8). In one embodiment, the pH of the slurry is at least 6. In another embodiment, the pH of the slurry is at least 7. The slurry pH in another embodiment is not more than 12. In other embodiments, the pH of the slurry is 6-10, 7.5-10.5 or 8-10. In still other embodiments, the pH of the slurry is 5-8 or 6-7.

The alcohol-treatment agent treatment of the starch may be effected by first placing the starch in the alcoholic medium and then adding treatment agent (e.g., base and/or salt). Alternatively, the treatment agent may be first combined with the alcoholic medium and then contacted with the starch. The treatment agent may be formed in situ, such as by separately adding a base and an acid which react to form the salt which functions as the treatment agent.

Suitable bases for use in the process include, but are not limited to, alkali metal and alkaline earth metal hydroxides such as potassium hydroxide, calcium hydroxide and sodium hydroxide.

Suitable salts for use in these methods include water-soluble substances which ionize in aqueous solution to provide a substantially neutral solution (i.e., a solution having a pH of from 6 to 8). Alkali metal-containing salts are particularly useful, as are salts of organic acids (e.g., a sodium or potassium salt) such as itaconic acid, malonic acid, lactic acid, tartaric acid, citric acid, oxalic acid, fumaric acid, aconitic acid, succinic acid, oxalosuccinic acid, glutaric acid, ketoglutaric acid, malic acid, fatty acids and combinations thereof.

Mixtures of different treatment agents may be used. For example, the starch may be heated in the alcoholic medium in the presence of both at least one base and at least one salt.

The starch, alcoholic medium and treatment agent are heated for a time and at a temperature effective to inhibit the starch to the desired extent. Generally speaking, temperatures in excess of room temperature (i.e., 35° C. or greater) will be necessary. At the same time, extremely high temperatures should be avoided. The heating temperature can be, for example, 35° C. to 200° C. Typically, temperatures of from 100° C. to 190° C., 120° C. to 180° C., or from 130° C. to 160° C., or from 140° C. to 150° C. will be sufficient. The heating time generally is at least 5 minutes but no more than 20 hours and typically 40 minutes to 2 hours. In general, a desired level of starch inhibition may be achieved more rapidly if the heating temperature is increased.

The specific conditions of time of treatment, temperature of treatment, and proportions of the components of the mixture of starch, alcoholic medium and treatment agent are generally selected such that the starch is not gelatinized to a significant extent. That is, the starch remains non-pregelatinized as described above.

When the temperature selected for the heating step exceeds the boiling point of one or more components of the alcoholic medium, it will be advantageous to carry out the heating step in a vessel or other apparatus capable of being pressurized. The treatment may be conducted within a confined zone in order to maintain the alcoholic medium in a liquid state. Additional positive pressure could be employed, but is generally not necessary. The starch may be slurried in the alcoholic medium together with the treatment agent under conditions of elevated temperature and pressure and treated for a time sufficient to change the starch's viscosity characteristics. Such treatment may be conducted in a stirred tank reactor on a batch basis or in a tubular reactor on a continuous basis, although other suitable processing techniques will be apparent to those skilled in the art. In another embodiment, the starch may be in the form of a bed within a tubular reactor and a mixture of the alcoholic medium and treatment agent passed through such bed (optionally, on a continuous basis), with the bed being maintained at the desired temperature to effect inhibition of the starch.

In embodiments in which a base has been utilized as a treatment agent, the mixture of starch, alcoholic medium and base may be combined with one or more acids, once the heating step is completed, for the purpose of neutralizing the base. Suitable acids for use in such neutralization step include, but are not limited to, carboxylic acids such as itaconic acid, malonic acid, lactic acid, tartaric acid, oxalic acid, fumaric acid, aconitic acid, succinic acid, oxalosuccinic acid, glutaric acid, ketoglutaric acid, malic acid, citric acid, fatty acids and combinations thereof, as well as other types of acids such as uric acid. If the inhibited starch is intended for use as a food ingredient, the acid generally should be selected to be one that is permitted for such use under applicable regulations. Typically, sufficient acid is added to lower the pH of the mixture to about neutral to slightly acidic, e.g., a pH of from about 5 to about 7 or from about 6 to about 6.5.

The neutralization with acid may be carried out at any suitable temperature. In one embodiment, the slurry of starch, base and alcoholic medium is cooled from the heating temperature used to approximately room temperature (e.g., about 15° C. to about 30° C.) prior to being combined with the acid to be used for neutralization. The neutralized mixture may thereafter be further processed as described below to separate the inhibited starch from the alcoholic medium. In another embodiment, however, neutralization of the base is followed by further heating of the starch slurry. Such further heating has been found to be capable of modifying the rheological properties of the inhibited starch obtained, as compared to the viscosity characteristics of an analogously prepared starch that has not been subjected to heating after neutralization of the base.

Generally speaking, such further heating step is advantageously carried out at temperatures in excess of room temperature (i.e., 35° C. or greater). At the same time, extremely high temperatures should be avoided. The heating temperature can be, for example, 35° C. to 200° C. Typically, temperatures of from 100° C. to 190° C., 120° C. to 180° C., or from 130° C. to 160° C., or from 140° C. to 150° C. will be sufficient. The heating time generally is at least 5 minutes but no more than 20 hours and typically 40 minutes to 2 hours.

The mixture of starch and alcoholic medium may be processed so as to separate the starch from the alcoholic medium. Conventional methods for recovering solids from liquids such as filtration, decantation, sedimentation or centrifugation may be adapted for such purpose. The separated starch may optionally be washed with additional alcoholic medium and/or alcohol and/or water to remove any undesired soluble impurities. In one embodiment, neutralization of residual base is accomplished by washing the recovered starch with an acidified liquid medium. Drying of the separated starch will provide an inhibited non-pregelatinized granular starch in accordance with the disclosure. For example, drying may be performed at a moderately elevated temperature (e.g., 30° C. to 60° C.) in a suitable apparatus such as an oven or a fluidized bed reactor or drier or mixer. Vacuum and/or a gas purge (e.g., a nitrogen sweep) may be applied to facilitate removal of volatile substances (e.g., water, alcohol) from the starch. The resulting dried inhibited non-pregelatinized starch may be crushed, ground, milled, screened, sieved or subjected to any other such technique to attain a particular desired agglomerate size. In one embodiment, the inhibited starch is in the form of a free-flowing agglomerate.

In one embodiment, however, the starch is subjected to a desolventization step at a significantly higher temperature (e.g., greater than 80° C. or greater than 100° C. or greater than 120° C.). Excessively high temperatures should be avoided, however, since degradation or discoloration of the starch may result. Such a step not only reduces the amount of residual solvent (alcohol) in the product but also provides the additional unexpected benefit of enhancing the degree of inhibition exhibited by the starch. Desolventization temperatures can, for example, be about 100° C. to about 200° C. Typical temperatures are 120° C. to 180° C. or 150° C. to 170° C. The desolventization may be carried out in the presence or in the absence of steam. Steam treatment has been found to be advantageous in that it helps to minimize the extent of starch discoloration which may otherwise occur at such an elevated temperature. In one embodiment, steam is passed through a bed or cake of the inhibited waxy starches based on maize, wheat, or tapioca. The starch desolventization methods of U.S. Pat. No. 3,578,498, incorporated herein by reference in its entirety for all purposes, may be adapted for use. Following steam treatment, the inhibited waxy starches based on maize, wheat, or tapioca may be dried to reduce the residual moisture content (e.g., by heating in an oven at a temperature of from about 30° C. to about 70° C. or in a fluidized bed reactor).

In one embodiment, the treated starch, which has been recovered from the alcoholic medium, is first brought to a total volatiles content of not more than about 35% by weight or not more than about 15% by weight. This can be accomplished, for example, by first air or oven drying the recovered starch at moderate temperature (e.g., 20° C. to 70° C.) to the desired initial volatiles content. Live steam is then passed through the dried starch, the system being maintained at a temperature above the condensation point of the steam. A fluid bed apparatus may be used to perform such a steam desolventization step.

In general, it will be desirable to carry out desolventization under conditions effective to result in a residual alcohol content in the inhibited unpregelatinized starches of less than 1 weight % or less than 0.5 weight % or less than 0.1 weight %.

Following desolventization, the inhibited unpregelatinized starches may be washed with water and then re-dried to further improve color and/or flavor and/or reduce the moisture content.

Of course, the person of ordinary skill in the art can use other methodologies to arrive at the inhibited unpregelatinized starch. The starch feedstock can, for example, be subjected to a pH adjustment and heated. The pH adjustment can be performed by contacting a pH-adjusting agent with the starch; examples of pH-adjusting agents include formic acid, propionic acid, butyric acid, oxalic acid, lactic acid, malic acid, citric acid, fumaric acid, succinic acid, glutaric acid, malonic acid, tartaric acid, itaconic acid, aconitic acid, oxalosuccinic acid, ketoglutaric acid, fatty acids, and carbonic acid, as well as salts thereof (e.g., potassium and/or sodium salts, which can be generated in situ by neutralization of the acid). The pH-adjusting agent can be contacted with the starch feedstock in any convenient fashion, e.g., as a slurry in liquid (e.g., water, alcohol (e.g., as described above, including ethanol or isopropanol), including aqueous alcohol such as aqueous ethanol, or another solvent); in dry form; in damp form (e.g., in a mist in a solvent (such as water, aqueous ethanol, or another solvent); or in the form of a damp dough of the starch (e.g., with water, aqueous ethanol, or another solvent). And when an alkali metal salt of an acid is to be used, it can be formed in situ, e.g., by adding the acid and an alkali metal hydroxide or carbonate in separate steps.

The pH adjustment can be performed to yield a variety of pH values. For example, in certain embodiments, and as described in WO 2013/173161, the pH adjustment can be performed to yield a pH in the range of 7-10. In other, alternative embodiments, the pH adjustment can be performed to yield a pH in the range of 3-7, e.g., in the range of 3-6, or 3-5, or 3-4, or 4-7, or 4-6, or 4.5-7, or 4.5-6, or 5-7, or 5-6, or about 3, or about 3.5, or about 4, or about 4.5, or about 5, or about 5.5, or about 6, or about 6.5, or about 7. When the pH adjustment is performed in a slurry, the pH of the slurry is the relevant pH. When the pH adjustment is performed in a substantially non-liquid form (e.g., a dough, or in damp solid), the pH of the solid material at 38% in water is the relevant pH. The amount of the pH-adjusting agent relative to the starch can vary, for example, from 0.05-30 wt % on a dry solids basis, e.g., 0.05-20 wt %, 0.05-10 wt %, 0.05-5 wt %, 0.05-2 wt %, 0.05-1 wt %, 0.05-0.5 wt %, 0.2-30 wt %, 0.2-20 wt %, 0.2-10 wt %, 0.2-5 wt %, 0.2-2 wt %, 0.2-1 wt %, 1-30 wt %, 1-20 wt %, 1-10 wt %, 1-5 wt %, 5-30 wt % or 5-20 wt %. Desirably, the pH adjusting agent is mixed thoroughly with the starch feedstock. This will require different process conditions depending on the form in which the pH adjustment is performed. If the pH adjustment is performed in a slurry, simply stirring the slurry for a few minutes may be sufficient. If the pH adjustment is performed in a drier form (e.g., in a damp solid or a dough), more substantial contacting procedures may be desirable. For example, if a solution of the pH-adjusting agent is sprayed onto dry starch feedstock, it can be desirable to mix for about 30 minutes then store for at least a few hours. It is desirable to provide for uniform distribution of the pH-adjusting agent throughout the starch, i.e., on a granular level, in order to provide uniform inhibition.

After the pH-adjusting agent is contacted with the starch, the starch can be heated (i.e. while still in contact with pH-adjusting agent). The starch can be heated in a variety of forms. For example, the starch can be heated in alcohol or non-aqueous solvent slurry (e.g., under pressure if the boiling point of the solvent not sufficiently above the heating temperature); as a dough of starch, water, and non-water solvent to suppress granular swelling (e.g., as disclosed in WO 2013/173161), or in a dry state (solvent can be removed using conventional techniques such as filtration, centrifugation and/or heat-drying, e.g. as described above with respect WO 2013/173161). The starch can be, for example, dried to a moisture level of less than 5% before further heating. Relatively low temperatures, e.g., 40-80° C., or 40-60° C., or about 50° C., can be used for such drying. Vacuum can also be used in the drying process. The starch can be dried as a result of the heating process (see below); a separate drying step is not necessary.

The dried starch can be heated at a temperature in the range of 100-200° C. For example, in certain methods, the heating temperature is 120-160° C. In other various methods, the heating temperature is 120-180° C., or 120-160° C., or 120-140° C., or 140-200° C., or 140-180° C., or 140-160° C., or 160-200° C., or 160-180° C., or 180-200° C. The starch can be heated for a variety of times. The starch can be heated for a time in the range of, for example, 20 seconds to 20 hours. Typical heating times are in the range of 10 minutes to two hours. Longer heating times and/or higher heat-treatment temperatures can be used to provide more inhibition. The material is desirably uniformly heated. The starch can be heated under pressure to maintain a desired moisture content, or it can be heated in a mass flow bin or similar device.

Certain methods described herein can be practiced, for example, using no alcohol in the liquid medium for the contacting with the pH adjustment. In certain particularly desirable methods, water is used as the medium for the pH adjustment. Accordingly, in certain desirable embodiments, the inhibited waxy starch based on maize, wheat, or tapioca comprises less than 500 ppm of alcohol solvent, e.g., less than 500 ppm ethanol. For example, in various embodiments, the inhibited waxy starch based on maize, wheat, or tapioca comprises less than 100 ppm, less than 50 ppm, less than 10 ppm, less than 5 ppm, or less than 1 ppm of alcohol solvent, e.g., less than 100 ppm, less than 50 ppm, less than 10 ppm, less than 5 ppm, or less than 1 ppm ethanol.

The heated starch can be allowed to cool then used as-is, or further treated as is conventional in the art. For example, the starch can be washed to provide even whiter color and more pleasant flavor. If a non-aqueous solvent is used, it can be desirable to remove as much solvent as possible. But if relatively low levels of the pH-adjusting agent are used, the final product can meet reasonable pH and ash targets without further washing.

Another aspect of the disclosure is a pregelatinized starch made by a method as described herein.

Another aspect of the disclosure is a method for preparing a food product, including dispersing a pregelatinized starch as described herein in a food product. The dispersion can be performed at a variety of temperatures. Notably, as the starch is pregelatinized, the dispersion need not be performed at high temperatures. Accordingly, in certain embodiments, the pregelatinized starch is dispersed in the food product at a temperature of no more than 95° C., e.g., no more than 90° C., no more than 70° C., or even no more than 50° C. In certain embodiments of the methods as otherwise described herein, the pregelatinized starch is dispersed in the food product at a temperature in the range of 15-95° C., e.g., 15-90° C., 15-70° C., 15-50° C., 15-30° C., 20-95° C., 20-90° C., 20-70° C., or 20-50° C. Of course, the pregelatinized starch can be dispersed in food at a different temperature, e.g., a higher temperature than those described here. For example, in some cases pregelatinized starches can be used in high-sugar foods in which cooking temperatures are very high. The pregelatinized starches can help to provide hydration in the presence of the sugar, which would otherwise prevent non-pregelatinized starch in the food from cooking.

The dispersion of the pregelatinized starch can be performed such that the starch granules remain substantially undisintegrated in the food product. For example, in certain embodiments of the methods as otherwise described herein, at least 50% (e.g., at least 75%, or even at least 90%) of the starch granules swell but do not substantially disintegrate when dispersed in the food product.

Another aspect of the disclosure is a food product that includes a starch as described herein dispersed therein. Desirably, the starch granules of the pregelatinized starch are substantially undisintegrated in the food product. For example, in certain embodiments of the methods as otherwise described herein, at least 50% (e.g., at least 75%, or even at least 90%) of the starch granules are swollen but not substantially disintegrated in the food product.

The pregelatinized starches of the disclosure can be used in a variety of food products. For example, in certain embodiments of the methods and food products as otherwise described herein, the food product is a liquid. In certain embodiments of the methods and food products as otherwise described herein, the food product is an oil-containing food product. In certain embodiments of the methods and food products as otherwise described herein, the food product is a soup, a gravy, a sauce, a mayonnaise, a dressing (e.g., a pourable or spoonable salad dressing), a filling (e.g., a fruit filling, such as a high-sugar fruit filling), a cream (e.g., a Bavarian cream), or a dairy product (e.g., a yogurt or a quark). For example, the pregelatinized starches of the present disclosure can be used in various embodiments in salad-dressings, mayonnaises, and various other oil/water emulsions such as cheese sauces, as well as in high-sugar fillings such as pie fillings. The starches described herein can also be included in baked goods.

The starches described herein can also advantageously be used in dry mixes, e.g., in instant dry mixes, for example for foods such as soups, sauces and baked goods. Accordingly, another aspect of the disclosure is a dry mix including one or more dry ingredients and a pregelatinized starch as described herein (i.e., in dry form).

The pregelatinized starches of the disclosure can be useful in egg-free food products, e.g., to provide properties otherwise provided by eggs; accordingly, in certain embodiments of the methods and food products as otherwise described herein, the food product is egg-free.

The starches described herein can be used in a wide variety of other foods. For example, in certain embodiments of the starches and methods of the disclosure, the starch is used in a food selected from baked foods, breakfast cereal, anhydrous coatings (e.g., ice cream compound coating, chocolate), dairy products, confections, jams and jellies, beverages, fillings, extruded and sheeted snacks, gelatin desserts, snack bars, cheese and cheese sauces, edible and water-soluble films, soups, syrups, sauces, dressings, creamers, icings, frostings, glazes, pet food, tortillas, meat and fish, dried fruit, infant and toddler food, and batters and breadings. The starches described herein can also be used in various medical foods. The starches described herein can also be used in pet foods.

Based on processed food formulations, the person of ordinary skill in the art may readily select the amount and type of the starches of the present disclosure required to provide the necessary texture and viscosity in the finished food product. Typically, the starch is used in an amount of 0.1-35%, e.g., 0.1-10%, 0.1-5%, 1-20%, 1-10%, or 2-6%, by weight, of a finished food product. The starches described herein can also be used in preblends and dry mixes, e.g., in amounts in the range of 0.1-95%, e.g., 0.1-80%, 0.1-50%, 0.1-30%, 0.1-15%, 0.1-10%, 0.1-5%, 1-95%, 1-80%, 1-50%, 1-30%, 1-15%, 1-10%, 5-95%, 5-80%, 5-50%, 5-30%, 20-95%, 20-80%, or 20-50%.

The starches of the present disclosure can in some particular food products have a surprisingly high stability. For example, in certain embodiments, when a starch of the disclosure is present in a food product with a sugar, it can provide enhanced stability. In other embodiments, when a starch of the disclosure is present in a food product with a fatty acid or a derivative thereof (e.g., a stearate), it can provide enhanced stability.

### Example 1

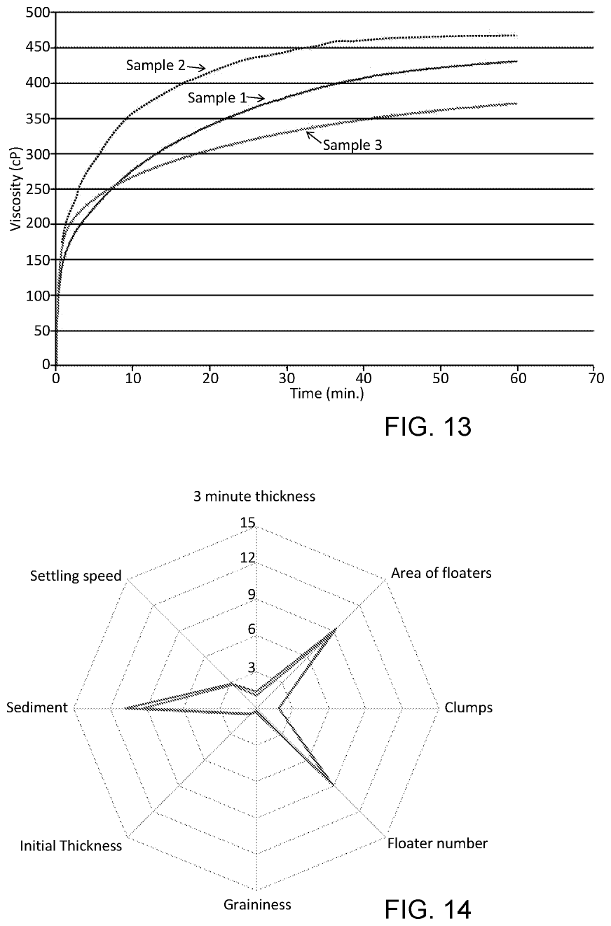

In an example preparation, inhibited starch having an RVA viscosity of 600-700 cP with sedimentation volume of 26 mL/g and made as described herein was drum dried at 37% solids on a Gouda single drum dryer (Model E5/5) (500 mm×500 mm) at 125 psig steam pressure and a drum speed of 8 rpm in three different runs, (conducted over a span of eleven months, with samples 2 and 3 being made nine and ten months later, respectively, than sample 1). Sample 2 used a starch having an RVA viscosity of 614 cP and a sedimentation volume of 26 mL/g as a starting material. Sample 3 used a starch having an RVA viscosity of 704 cP and a sedimentation volume of 26 mL/g as a starting material. Sample 1 used a blend of the materials. Materials were milled with a Fitz knife. Measured data for the pregelatinized starches so produced are provided in the table below, while FIGS. 12 and 13 respectively provide an RVA plot and a hydration RVA plot for the three samples.

Example 1

| Sample | 1 | 2 | 3 |
|---|---|---|---|
| Moisture (%) | 4.50 | 4.41 | 1.70 |
| pH | 5.70 | 5.71 | 6.04 |
| RVA - 5 min cPs | 340 | 416 | 410 |
| RVA - 10 min cPs | 380 | 462 | 470 |
| RVA - Initial cPs | 410 | 487 | 509 |
| RVA - End cPs | 727 | 698 | 739 |
| RVA - Time to Peak (min) | 15 | 15 | 15 |
| USV-95° C. (mL/g) | 28.5 | 29.0 | 31.0 |
| Solubles 95° C. (%) | | 12.0 | 13.5 |
| USV-RT (mL/g) | 25.0 | 25.5 | 24.5 |
| Solubles RT (%) | | 9.6 | 10.8 |
| RVA - Hydration 15 min cPs | 290 | 390 | 310 |
| RVA - Hydration 1 hr cPs | 370 | 467 | 430 |
| Screen Retained on 60 (%) | 0.2 | 0.16 | 0.04 |
| Screen Retained on 100 (%) | 1.1 | 0.88 | 0.48 |
| Screen Retained on 200 (%) | 14.8 | 11.29 | 11.21 |
| Screen Passed Through 200 (%) | 83.9 | 87.67 | 88.45 |

Samples 1 and 2 were submitted for sensory evaluation for their dispersion and textural characteristics. FIG. 14 illustrates the dispersion behavior for these two materials. While the earlier-made batch (1) has slightly more sediment and floaters than the newer batch, the difference is not significant.

### Example 2

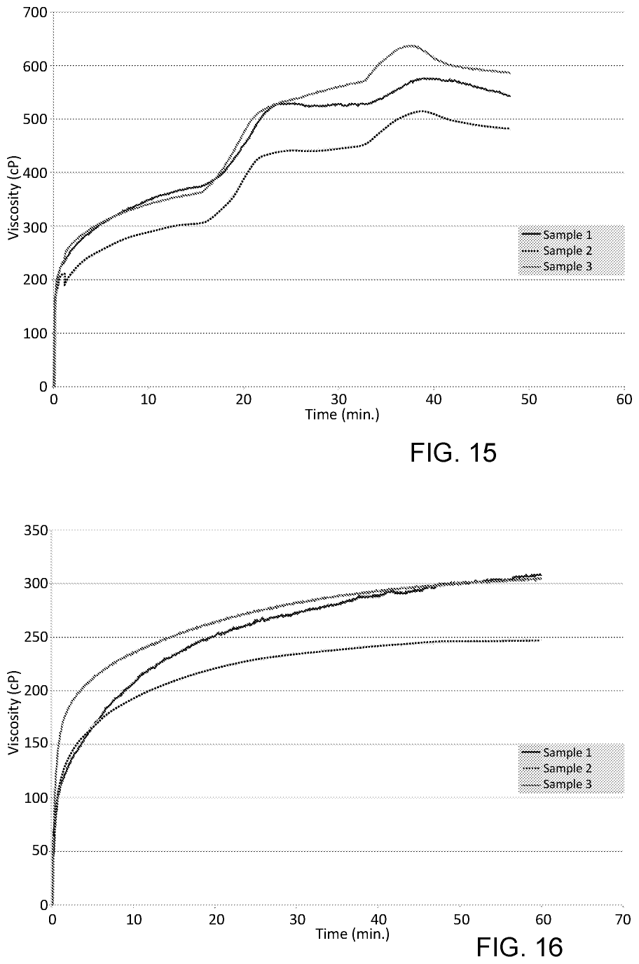

In another example preparation, inhibited starch having an RVA viscosity of 243 and 405 cP with sedimentation volumes of 24 and 23 ml, respectively, and made as described herein was drum dried at 37% solids on a Gouda single drum dryer (Model E5/5) (500 mm×500 mm) at 125 psig steam pressure and a drum speed of 8 rpm in three different runs (conducted over a span of eleven months, with samples 5 and 6 being made nine and ten months later, respectively, than sample 4). Sample 5 used a starch having an RVA viscosity of 243 cP and a sedimentation volume of 24 mL/g as a starting material. Sample 3 used a starch having an RVA viscosity of 405 cP and a sedimentation volume of 23 mL/g as a starting material. Sample 4 used a blend of the materials. Materials were milled with a Fitz knife. Measured data for the pregelatinized starches so produced are provided in the table below, while FIGS. 15 and 16 respectively provide an RVA plot and a hydration RVA plot for the three samples.

Example 2

| Sample | 4 | 5 | 6 |
|---|---|---|---|
| Moisture (%) | 3.90 | 4.32 | 2.72 |
| pH | 5.70 | 5.64 | 5.91 |
| RVA - 5 min cPs | 310 | 254 | 310 |
| RVA- 10 min cPs | 340 | 289 | 350 |
| RVA - Initial cPs | 360 | 304 | 375 |
| RVA - End cPs | 588 | 482 | 547 |
| RVA - Time to Peak (min) | 15 | 15 | 15 |
| USV-95° C. (mL/g) | 28.0 | 27.5 | 29.0 |
| Solubles 95° C. (%) | | 10.75 | 12.0 |
| USV-RT (mL/g) | 24.0 | 23.0 | 24.0 |
| Solubles RT (%) | | 9.11 | 8.5 |
| RVA - Hydration 15 min cPs | 250 | 210 | 230 |
| RVA - Hydration 1 hr cPs | 300 | 247 | 308 |
| Screen Retained on 60 (%) | 0.3 | 0.68 | 0.08 |
| Screen Retained on 100 (%) | 1.1 | 1.96 | 0.42 |
| Screen Retained on 200 (%) | 16.4 | 12.47 | 10.60 |
| Screen Passed Through 200 (%) | 82.2 | 84.89 | 88.58 |

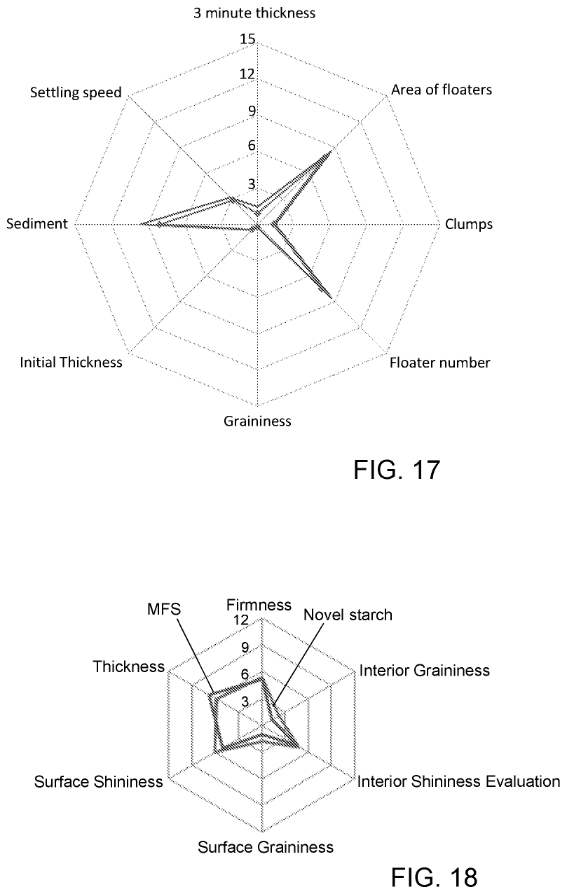

Samples 4 and 5 were submitted for sensory evaluation for their dispersion and textural characteristics. FIG. 17 illustrates the dispersion behavior for these two materials. While the earlier-made batch (4) has slightly more sediment and floaters than the newer batch, the difference is not significant.

### Example 3

A starch of the disclosure and a conventional modified food starch were each made into a Bavarian cream. The batch formula is provided below:

| | % | Grams |
|---|---|---|
| Sucrose, baker's special granulation | 26.60 | 1064.06 |
| Water | 63.77 | 2550.72 |
| Canola oil | 3.26 | 130.29 |
| STARCH | 5.97 | 238.84 |
| Titanium dioxide | 0.10 | 4.06 |
| Sodium benzoate | 0.10 | 4.06 |
| Sorbic acid | 0.10 | 4.06 |
| Vanilla flavor * | 0.06 | 2.46 |
| Citric acid | 0.03 | 1.30 |
| Color * | 0.00 | 0.14 |
| | 100.00 | 4000.00 |

* Flavor: Takasago Natural Creamy Vanilla (TAK-120765)
* Color: GFS Egg Shade

Oil was coated onto sucrose in a Hobart mixer using a wire whisk at speed two for two minutes. The remainder of the dry ingredients were pre-blended and added to the oiled sucrose, with blending at speed two for two more minutes. Hot water was added slowly while mixing on speed one for a total of one minute. Mixing was continued for four minutes at speed two, after which the cream was stored refrigerated. Results of textural analysis are shown in FIG. 18. The starch of the disclosure exhibited good thickening power, good shininess and low graininess, comparable to the modified food starch. Moreover, the color was very low, much lower than a Bavarian cream made with a conventional “clean label” starch, and indicating a low Yellowness Index of the starch of the disclosure.

A starch of the disclosure (Sample 6) and a conventional modified food starch were each made into a spoonable salad dressing. The batch formula is provided below:

| | % | Grams |
|---|---|---|
| Soybean Oil | 38.70 | 3096.00 |
| Water | 37.79 | 3023.20 |
| Vinegar, 120 grain | 7.70 | 616.00 |
| Egg yolk, pasteurized, frozen, 10% salt | 3.50 | 280.00 |
| STAR-DRI ® 42C Corn Syrup Solids | 4.10 | 328.00 |
| ISOSWEET ® 100 HFCS | 3.75 | 300.00 |
| Starch | 3.25 | 260.00 |
| Salt | 0.82 | 65.60 |
| Xanthan Gum, 200 Mesh | 0.25 | 20.00 |
| Potassium Sorbate | 0.14 | 11.20 |
| | 100.00 | 8000.00 |

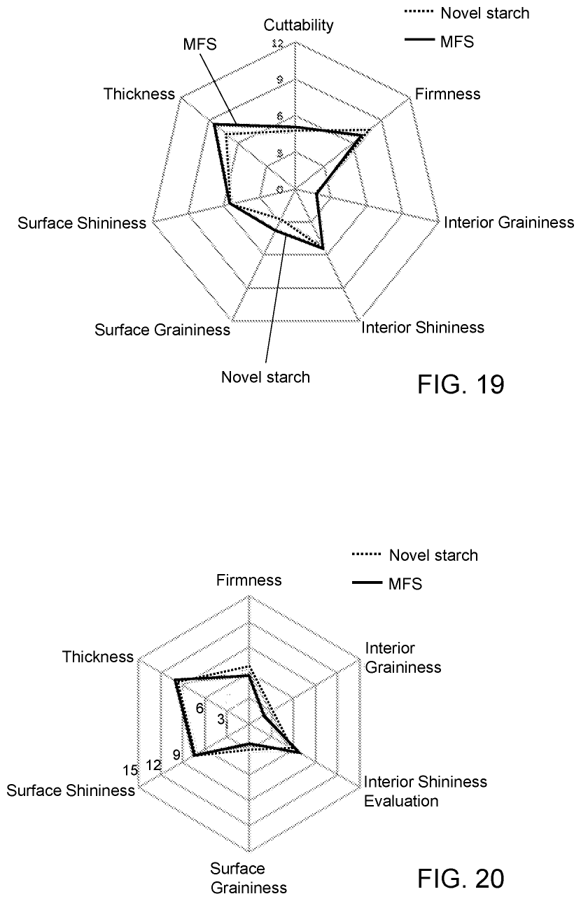

To prepare the dressing, the Isosweet® 100 and water were placed in a Hobart mixing bowl. Dry-blended STAR-DRI® 42C, salt and potassium sorbate were added to the bowl with mixing and dispersed. The xanthan gum was dispersed in a small amount of oil and added to the bowl, allowing it to hydrate for five minutes. Vinegar was then added. The starch was dispersed in a small amount of oil and added to the bowl; agitation was continued to allow the material to hydrate for 5 minutes. Egg yolk was added. The remaining oil was added slowly to create a pre-emulsion. A final emulsion was created by passing the material through a colloid mill. Results of textural analysis are shown in FIG. 19. The starch of the disclosure exhibited good thickening power, good shininess and low graininess, comparable to the modified food starch.

A starch of the disclosure (Sample 3) and a conventional modified food starch were each made into a high-solids fruit filling. The batch formula was:

| Component | % | Grams |
|---|---|---|
| ISOSWEET ® 5500 | 57.56 | 2302.40 |
| STARCH | 5.25 | 210.00 |
| Water | 11.78 | 471.20 |
| Raspberry flavor | 0.30 | 12.00 |
| KRYSTAR ® 300 | 24.85 | 994.00 |
| Malic acid, | 0.10 | 4.00 |
| Citric acid, | 0.10 | 4.00 |
| Red coloring | 0.06 | 2.40 |
| | 100.00 | 4000.00 |

To prepare the filling the Isosweet® 5500 was placed in a Hobart mixing bowl. The starch was slowly added while mixing on speed 1 until starch was fully dispersed (2-4 minutes). Flavorings, colorings and water were added, and the mixture blended for 1 minute on speed 1. The mixture was allowed to rest until it became thick. Preblended KRYSTAR® 300 and acidulants were added, and the mixture blended until uniform. Results of textural analysis are shown in FIG. 20. The starch of the disclosure exhibited good thickening power, good shininess and low graininess, comparable to the modified food starch.

The particulars shown herein are by way of example and for purposes of illustrative discussion of various aspects and embodiments of the materials and methods of the present disclosure, and are presented in the cause of providing what is believed to be the most useful and readily understood description of the principles and conceptual aspects thereof. In this regard, no attempt is made to show details of the starches and methods described herein in more detail than is necessary for the fundamental understanding thereof, the description taken with the drawings and/or examples making apparent to those skilled in the art how various forms thereof may be embodied in practice. Thus, before the disclosed materials and methods are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the materials and methods disclosed herein (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from one particular value, and/or to another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the materials and methods of the disclosure and does not pose a limitation on the scope of the materials and methods otherwise disclosed. No language in the specification should be construed as indicating any non-claimed element as being essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained in the materials and methods of the disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the materials and methods disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified.

Some embodiments of the methods and materials are described herein. Of course, variations on these described embodiments will become apparent to those of ordinary skill in the art upon reading the foregoing description. The present inventors expect skilled artisans to employ such variations as appropriate, and the intend for the materials and methods of the disclosure to be practiced otherwise than specifically described herein. Accordingly, this disclosure contemplates all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents and printed publications throughout this specification. Each of the cited references and printed publications are individually incorporated herein by reference in their entirety.

In closing, it is to be understood that the embodiments of the methods and materials disclosed herein are illustrative of the principles of the present disclosure. Other modifications that may be employed are within the scope of the disclosure. Thus, by way of example, but not of limitation, alternative configurations of the materials and methods of the present disclosure may be utilized in accordance with the teachings herein. Accordingly, the present disclosure is not limited to that precisely as shown and described.

What is claimed is:

1-67. (canceled)

68. A pregelatinized starch having no more than 15 wt % solubles, a Yellowness Index no more than 10, and a sedimentation volume in the range of 20 mL/g to 45 mL/g, the pregelatinized starch being in the form of agglomerates comprising starch particles, the pregelatinized starch being in a substantially planar form.

69. The pregelatinized starch of claim 68, wherein the pregelatinized starch is a drum-dried starch.

70. The pregelatinized starch of claim 68, wherein at least 50% of the starch particles swell but do not substantially disintegrate when processed in 95° C. water.

71. The pregelatinized starch of claim 68, wherein the starch has a sedimentation volume in the range of 20 mL/g to 30 mL/g.

72. The pregelatinized starch of claim 68, having no more than 10% solubles.

73. The pregelatinized starch of claim 68, having no more than 5% solubles.

74. The pregelatinized starch of claim 68, having a viscosity in the range of 50-1500 cP in an RVA test.

75. The pregelatinized starch of claim 68, wherein at least 90% of the agglomerates of the pregelatinized starch have a substantially non-rounded shape.

76. The pregelatinized starch of claim 68, wherein at least 90% by weight of the pregelatinized starch is in the form of individual sheet- or flake-like agglomerates of material each having a thickness that is no more than ½ of each of the length and the width of the agglomerate.

77. The pregelatinized starch of claim 68, wherein the pregelatinized starch is not chemically-modified.

78. The pregelatinized starch of claim 68, wherein the pregelatinized starch is not hydroxypropylated, is not acetylated, is not carboxymethylated, is not hydroxyethylated, is not phosphate, is not succinated, is not cationic or zwitterionic, is not crosslinked with phosphate, is not crosslinked with adipate, is not crosslinked with epichlorohydrin, is not crosslinked with acrolein.

79. The pregelatinized starch of claim 68, wherein the pregelatinized starch is not bleached or oxidized with peroxide or hypochlorite.

80. The pregelatinized starch of claim 68, wherein the pregelatinized starch is not dextrinized, and substantially lacks 1,2- and 1,3-branching.

81. The pregelatinized starch of claim 68, wherein the pregelatinized starch has less than 10% fiber.

82. The pregelatinized starch of claim 68, wherein the starch is a corn starch.

83. The pregelatinized starch of claim 68, wherein the starch is a tapioca or cassava starch.

84. A method for making a pregelatinized starch of claim 68, comprising providing an ungelatinized starch moistened with an aqueous medium; and drum-drying the moistened ungelatinized starch under conditions sufficient to pregelatinize the starch.

85. A method for preparing a food product, comprising dispersing a pregelatinized starch according to claim 68 in a food product, wherein at least 90% of the starch granules swell but do not substantially disintegrate when dispersed in the food product.

86. The method according to claim 85, wherein the food product is a soup, a gravy, a sauce, a dressing (e.g., a salad dressing), a filling (e.g., a fruit filling), a cream (e.g., a Bavarian cream), a dairy product (e.g., a yogurt or a quark), or a frozen food.

87. A food product comprising a starch of claim 68 dispersed therein.
